(19) United States
(12) Patent Application Publication
(10) Pub. No.: US 2021/0141791 A1
(43) Pub. Date: May 13, 2021

(54) METHOD AND SYSTEM FOR GENERATING A HYBRID DATA MODEL

(71) Applicant: ADOBE INC., San Jose, CA (US)

(72) Inventors: Sandeep Nawathe, Sunnyvale, CA (US); Vineet Sharma, San Jose, CA (US); Ravi Aggarwal, San Jose, CA (US); Raghavendra Kumar Pandey, San Jose, CA (US); Antonio Cuevas, Mountain View, CA (US)

(21) Appl. No.: 16/839,960

(22) Filed: Apr. 3, 2020

Related U.S. Application Data
(60) Provisional application No. 62/934,722, filed on Nov. 13, 2019.

(51) Int. Cl. G06F 16/2458; G06F 16/2457

(52) U.S. Cl. CPC G06F 16/2465; G06F 16/24575

(57) ABSTRACT

Embodiments of the present disclosure are directed to a system, methods, and computer-readable media for generating a hybrid data model. In embodiments, data feeds having different identities are used to generate profile fragments in one environment while relationships between the different identities are discerned in a separate environment. When a query is executed, an identity-based graph is generated to create a snapshot of the relationships determined at that time. Using the identity-based graph, those identities having a relationship to one another and to the query are determined. Profile fragments that correspond to the query-related identities are then aggregated together into a single hybrid data model.

### CROSS REFERENCE TO RELATED APPLICATION

This patent application is a non-provisional application that claims the benefit of priority to U.S. Provisional Application No. 62/934,722 filed on Nov. 13, 2019, which is incorporated herein by reference in its entirety.

### BACKGROUND

Current data models may efficiently handle an analytical workload or an operational workload, but not both. Although operational data systems and analytical data systems are both capable of providing information to an entity, operational and analytical data systems are structurally different (i.e., different data model schemas) and provide different informational insights. For example, an operational data system operates to record day-to-day transactions of an entity's operations and performs operational workloads such as creating, reading, updating, or deleting discrete data points. In contrast, analytical data systems are generally used to perform analytical workloads, which involve analyzing the operational data and generating a report of the results of the analysis for the entity.

Due to the structural (i.e., different data model schemas) and functional differences between the two data systems, there are computing tradeoffs and informational sacrifices that must be made when an entity chooses to use an operational data system over an analytical data system, and vice versa. For example, analytical data systems may be capable of performing a Join Query, while an operational data system cannot. Also, analytical workloads are not efficiently performed when utilizing an operational data model schema, and operational workloads are not efficiently performed when utilizing an analytical data model schema. Particular problems and failures arise when time-series data and time-invariant (i.e., time independent) data are to be combined from different tables, as well. For example, both analytical data systems and operational data systems exhibit poor performance of real-time batch segmentation, as these data systems cannot handle data in motion (i.e., data being dynamically updated in real-time or near real-time).

Accordingly, there are no current data models that can operate efficiently to handle both analytical workloads and operational workloads, such that an entity must choose one data system over another and accept the technological limitations of that data system.

### SUMMARY

In brief and at a high level, various embodiments of the present invention provide a system, method, and computer-readable media for generating a hybrid data model. The hybrid data model discussed herein can be used to efficiently perform both operational and analytical workloads without the computing limitations and without the informational sacrifice (e.g., data loss from a hard merge) of other data systems. Thus, the hybrid data model overcomes the technological limitations and tradeoffs found in operational and analytical data systems, and an entity is no longer forced to accept one data system and corresponding technological limitations and shortcomings.

The hybrid data model generated herein combines data sets from data feeds, received from multiple and variant systems. At a high level, data from the data feeds may be classified as attribute values (e.g., time-invariant data such as name-value pairs) or as behavioral data (e.g., time-series data such as event level data). Generally, attribute values may be organized using a type-based relational data model whereas behavioral data may be organized using an identity-based document-oriented data model. A type-based relational data model utilizes a different schema than an identity-based document-oriented data model, and tradeoffs occur with different workloads performed against each data model. For example, simple point lookups are difficult when performed against attribute values in a type-based relational data model, and query processing against behavioral data in an identity-based document-oriented data model is computationally expensive.

In the hybrid data model, however, all data sets received from data feeds are provided distinct identities, independent of whether the data sets include time-invariant or time-series data. The data sets are used to build profile fragments in one environment, and each fragment corresponds to a distinct identity. Then, in a separate environment, the hybrid data model operates to relate the distinct identities to one another, and further relates the distinct identities to a single profile (e.g., one consumer profile for John Doe) based on a query for said profile. The hybrid data model, referred to as a unified profile, is constructed by joining and/or combining the profile fragments having distinct identities that are related to each other and the one profile together into a single document or object. Thus, the unified profile is a hybrid data model that contains merged fragments of both attribute value pairs and behavioral data, for example.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The present invention is defined by the claims as supported by the Specification, including the Detailed Description and Drawings.

### BRIEF DESCRIPTION OF THE DRAWINGS

Embodiments are described in detail below with reference to the attached drawing figures, wherein:

FIG. 1 illustrates an example operating environment for implementing embodiments in accordance with the present invention;

FIG. 2 illustrates an example of a unified profile in accordance with an embodiment;

FIG. 3 illustrates an example of a method in accordance with an embodiment;

FIG. 4 illustrates an example of a method in accordance with an embodiment; and

FIG. 5 illustrates an example of a device in accordance with an embodiment.

### DETAILED DESCRIPTION OF THE INVENTION

The subject matter of the present invention is being described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step,” “instance,” and/or “block” may be used herein to connote different elements of methods employed, the terms should not be interpreted as implying any particular order among or between various steps herein disclosed unless and except when the order of individual steps is explicitly described. The present disclosure will now be described more fully herein with reference to the accompanying drawings, which may not be drawn to scale and which are not to be construed as limiting. Indeed, the present invention may be embodied in many different forms and should not be construed as limited to the embodiments set forth herein.

Various terms and phrases are used herein to describe embodiments of the present invention. Some of the terms and phrases used herein are described here, but more details are included throughout the description.

CRM Customer Relationship Management

CRMID Customer Relationship Management Identification

DMP Data Management Platform

ESP Email Service Provider

ML Workload Machine Learning Workload

OLAP Online Analytical Processing

OLTP Online Transaction Processing

### Overview

There are currently no data models that can efficiently handle both analytical workloads and operational workloads. For example, a type-based relational data model can perform time-series queries but cannot perform as single point-lookup, also referred to a “scatter-gather query,” and cannot handle operational workloads. In another example, identity-based document-oriented data model can perform a single point-lookup and can handle an operational workload, but cannot perform time-series queries, for example. As used herein, “data model” refers to an information schema that determines the structuring and organizing of data and data sets. “Workload” refers to queries that are continually or continuously run against one or more profiles, as discussed herein. The terms “workload,” “query,” “streaming query,” and “batch query” may be used interchangeably for simplicity. At a high level, a “query” may also refer to a computer function comprising one or more of a read, an insert, an update, and/or a delete. Although “query” may be used in the singular, it will be understood that the term can include a plurality of queries, such as a streaming or batch query comprising multiple reads, inserts, updates, and/or deletes.

Embodiments of the hybrid data model can concurrently and efficiently handle both analytical workloads and operational workloads. At a high level, embodiments herein discuss the construction of a hybrid data model that leverages and merges aspects of document-oriented data models and relational data models. A “relational data model” refers to a data model that structures and organizes data based on data types. For example, data of similar data types, or data of the same data type, are structured and organized into tables where the tables are specific to said data type(s). The terms “relational data model,” “type-based data model,” and “type-based relational data model” are used interchangeably herein. In contrast, a “document-oriented data model” generally refers to a data model that structures and organizes data based on an identity of the data (e.g., a document, object, or record). The terms “document-oriented data model,” “identity-based data model,” and “identity-based document-oriented data model” are used interchangeably herein.

The hybrid data model generates profile fragments based on data type (i.e., type-based relational approach) when data sets are received, and each individual profile fragment is associated with a distinct identity (i.e., identity-based document-oriented approach). In embodiments, all data sets received from data feeds are provided distinct identities, independent of whether the data sets include time-invariant or time-series data. Then, in a separate environment, the hybrid data model operates to relate the distinct identities to one another, and further relates the distinct identities to a single profile (e.g., one consumer profile for John Doe) based on a query for said profile. The profile fragments of a user may be merged to generate a unified profile at any given point in time, based on identification of relationships between the distinct identities of the profile fragments. The hybrid data model, referred to as a unified profile, is constructed by joining and/or combining the profile fragments having distinct identities that are related to each other and the one profile together into a single document or object. Thus, the unified profile is a hybrid data model that contains merged fragments of both attribute value pairs and behavioral data, for example. By employing aspects of document-oriented data models and relational data models, the embodiments of the hybrid data model address and overcome the technological problems and technological limitations of other data models.

### Example System

Beginning with FIG. 1, a query processor 100 is depicted. The query processor 100 discussed herein may comprise one or more computing devices, for example, connected using a network 102 (e.g., short range wireless network, long range wireless network such as telecommunications, a cloud network, a distributed network, an Internet connection). Although the query processor 100 is shown in the singular in FIG. 1 for simplicity, the illustration is merely an example and is not limiting in this regard. The query processor 100 may be configured and/or enabled with one or more data storage modes, in embodiments. The query processor 100 may, in some embodiments, be configured to execute computer program code using one or more computer programming query languages. The query processor 100 may use one or more operating systems (OS), in various embodiments (e.g., XDM). In some embodiments, the query processor 100 comprises one or more virtual servers. In another embodiment, the query processor 100 is a physical server having a processor and memory.

The query processor 100 may communicate with one or more data sources 104 and 106. The one or more data sources 104 and 106 provide data feeds, in some embodiments. In embodiments, at least one of the data sources (e.g., data source 104) provides a data feed of Internet-based data. Additionally or alternatively, at least one of the data sources (e.g., data source 106) provides a data feed of behavioral event-based data, in some embodiments. In one embodiment, at least one of the data sources provides a data feed of time-invariant data, such as attribute value pairs. The data feeds may comprise structured data, unstructured data, and/or semi-structured data, in embodiments. The data feeds may include data having different data model schemas (e.g., identity-based or type-based), in an embodiment. The data feeds may include online, offline, and mobile audience data, for example, received from a data source that comprises a data management platform (DMP). The data feeds may include customer relationship data, for example, from a data source that comprises a Customer Relationship Management (CRM) system. In another example, the data feeds may include communications data and/or notification data from a data source that comprises an Email Service Provider (ESP). The terms “data feed” and “data stream” are used interchangeably to, generally, refer to continuously input data or continually input data.

In embodiments, the query processor 100 receives one or more data feeds 107 and 109 from the one or more data sources 104 and 106. In further embodiments, the query processor 100 may receive a plurality of data feeds from the one or more data sources 104 and 106. The data feeds 107 and 109 may be continually received (i.e., near or less than continuous) or continuously received by the query processor 100, in embodiments. The data feeds 107 and 109 may be received periodically or intermittently, in other embodiments. In various embodiments, the query processor 100 may receive the one or more data feeds 107 and 109 intermittently, and may concurrently receive one or more other data feeds continually or continuously. As such, the periodicity or continual nature of data receipt may be related to the data source of the data feed, in some embodiments.

The data feeds 107 and 109 may comprise information encoded using one or more different data formats, data structures, data types, structured data, and/or unstructured (i.e., raw) data. The data feeds 107 and 109 may include time invariant data and time-series data, in various embodiments. “Time invariant data” refers to profile data having time invariant attribute values. Examples of time invariant data include CRM attribute value data (e.g., age, gender, opt-in), computed attributes (e.g., propensity score, churn score), and segments (e.g., traits). In contrast, “time-series data” refers to consumer data represented as a set of time-series event. Examples of time-series data refers to behavioral events such as page views, website visits, online store visits, clicks, impressions, and profile updates. Examples of time-series data may also refer to profile update events such as segment updates and address updates.

The query processor 100 may comprise a hydration environment 108, in some embodiments. In embodiments, the hydration environment 108 may be a defined, distinct computer processing environment or system that is hosted by or is associated with the query processor 100. Although the hydration environment 108 is shown as being hosted locally by the query processor 100, it will be understood that the hydration environment 108 may not be physically associated with a server, as the server may be a virtual server, for example. As such, the hydration environment 108 may be remotely hosted on one or more computer devices that together comprise the query processor 100, in some embodiments. The hydration environment 108 of the query processor 100 may determine a plurality of identities for the one or more data feeds 107 and 109 that are received, in embodiments. For example, the hydration environment 108 of the query processor 100 may determine a unique or distinct identity for each of a plurality of data feeds, including the data feeds 107 and 109. The hydration environment may determine an identity for a particular data feed, wherein the identity distinctly labels the data type of the data feed.

The hydration environment 108 may generate a plurality of fragments for the plurality of identities in near real-time, as the data feeds 107 and 109 are received by the query processor 100. The terms “profile fragment” and “fragment” are used interchangeably herein to, generally, refer to a document or a container that stores a collection, set, or plurality of discrete profile data sets or data points. Each profile fragment corresponds to one identity, in embodiments. For example, a fragment comprising a CRM dataset may correspond to the identity CRMID. In another example, a fragment comprising mobile behavior data may correspond to the identity IDFA. A fragment comprising offline transactions may correspond to the identity phone number, in yet another example. A fragment comprising anonymous website behavior may, for example, correspond to the identity cookie. In one example, a fragment comprising known website behavior may correspond to the identity login.

In further embodiments, the hydration environment 108 may continually generate a plurality of fragments for the plurality of identities in near real-time, for example, with receipt of the data feeds 107 and 109 or with determining the plurality of identities. In embodiments, each one of the plurality of fragments generated corresponds to one of the plurality of identities. Each fragment may act as a container, wherein the fragment holds the profile data that is associated with an identity. Each fragment may include one or more fields, such as, for example, “ID” (identity), “kv” (key-value), and/or “ts” (time-series). Fragments for one identify may be generated from both time invariant data and time-series data, in embodiments.

The query processor 100 may comprise an identity component 110, in some embodiments. In embodiments, the identity component 110 may be a defined, distinct computer processing environment or system (e.g., identify-graph environment) that is hosted by or is associated with the query processor 100. In further embodiments, the identity component 110 may be separate and distinct from the hydration environment 108, for example, even when both the identity component 110 and the hydration environment 108 are associated with and/or are hosted by the query processor 100. Although the identity component 110 is shown as being hosted locally by the query processor 100, it will be understood that the identity component 110 may not be physically associated with a server, as the server may be a virtual server, for example. As such, the identity component 110 may be remotely hosted on one or more computer devices that together comprise the query processor 100, in some embodiments.

The identity component 110 of the query processor 100 may access the one or more data feeds 107 and 109 received by the query processor 100, in embodiments, in near real-time. The identity component 110 of the query processor 100 may determine one or more relationships between the plurality of identities, for example, in near real-time. In other words, the identity component 110 identifies whether there are relationships between two or more identities and the data feeds 107 and 109 to which the two or more identities correspond. For example, the identity component 110 may determine that an identity “credit card” is related to or matches an identity “email” based on the data in corresponding data feeds. In the example, the identity environment may determine that the identity “email” is related to or matches the identity “cookie” based on user login data in a data feed. In this manner, the identity component 110 determines and identifies relationships between identities.

In some embodiments, the identity component 110 of the query processor 100 may determine that a plurality of relationships between the plurality of identities, for example, in near real-time. In further embodiments, the identity component 110 may continually determine a plurality of relationships between the plurality of identities in near real-time. For example, new relationships may be discerned and/or existing relationships may be torn down in the identity component 110 as data streams into the query processor 100. The relationships may be determined in near real-time with the receipt of the one or more data feeds 107 and 109, or in near real-time when the identities are being determined via the hydration environment 108. In embodiments, the identity component 110 may continually, continuously, intermittently, or periodically determine and identity each of a plurality of relationships between the plurality of identities in near real-time, for example, with receipt of the data feeds 107 and 109 or with determining the plurality of identities. As such, relationships determined between various identities may be stored and/or updated. The identity component 110 (e.g., environment) operates separately from the hydration environment 108, in embodiments, such that the relationships and fragments are generated and evolve independent from one another.

In various embodiments, the query processor 100 may receive a streaming or batch query 111. The streaming or batch query 111 may be sent by a query database 114, in some embodiments. The query database 114 may store a streaming or batch query 111 that comprises a plurality of queries (e.g., at a scale of a streaming or batch query comprising 100,000 or more active queries), in embodiments. In embodiments, the plurality of queries of the streaming or batch query 111 correspond to one user or one profile for an individual user. For example, a streaming or batch query 111 may include queries for identifying and returning information that is related to a particular profile, where the particular profile is associated with an individual user and/or the electronic behavior or Internet-based actions of the individual user. In embodiments, the streaming or batch query 111 specifies a profile for which data is desired to be returned, or may specify an identity associated with a profile.

When a streaming or batch query 111 is received, the query processor 100 may load the active queries of the streaming or batch query 111 into memory and further, may index the queries of the streaming or batch query 111. In one embodiment, the streaming or batch query 111 is loaded into memory by the query processor 100, and the streaming or batch query 111 is indexed into a cube (e.g., an OLAP-type cube data structure).

In embodiments, the query processor 100 is configured to concurrently execute the plurality of active queries in the streaming or batch query 111 against one profile. For this reason, a unified profile data model is generated, as discussed further below, by generating an identity-based graph and joining corresponding fragments into a unified profile. Accordingly, all active queries in a streaming or batch query are executed for a particular profile together (i.e., all queries in a streaming or batch query are run at one time against one generated unified profile), in further embodiments. In contrast, other technologies may only execute a single query at a time, for example, against a plurality of profiles (i.e., one single query is executed against all of a plurality of profiles in a database). The term “unified profile” refers to, generally, a hybrid data model that comprises a logical collection or set comprised of one or more profile fragments merged into a single document or single object. A unified profile, in embodiments, comprises all of the profile fragments and all of the identities that correspond to one profile for a particular user. A unified profile generally corresponds to one user, in some embodiments. For example, each of a plurality of unified profiles corresponds to a different user.

Based on the streaming or batch query 111 that is to be executed against a unified profile, an identity-based graph that represents the relationships determined by the identity component 110 may be generated. The terms “identity graph,” “identity-based graph,” and “graph” are used interchangeably herein to refer to a representation of one or more logical relationships that are identified between distinct identities of data feeds and/or channel interactions. As such, the relationships in the identity-based graph that is generated may correspond to the profile. In further embodiments, the identity-based graph is generated in response to the streaming or batch query, wherein the identity-based graph represents the plurality of relationships being continually determined by the identity component 110. The identity-based graph may represent the plurality of relationships between identities that have been identified and have been determined to exist, as assessed at the time the streaming or batch query 111 is processed, in embodiments. The identity-based graph that is generated in response to the streaming or batch query 111 therefore represents a “snapshot” of the state of the determined relationships between identities as assessed or existing at the time the streaming or batch query 111 is received. Because the relationships between identities are being discerned on an on-going basis, the identity-based graph provides a time-specific view of said relationships. As discussed above, new relationships may be discerned and/or existing relationships may be torn down by the identity component 110 as data streams into the query processor 100. Thus, data in motion is used in the generation of the unified profile, such that the unified profile supports real-time batch segmentation without the performance problems found in other data systems.

Continuing, the query processor 100 may determine that one or more identities are related to the one profile of the streaming or batch query 111 based on the plurality of relationships in the identity-based graph generated, in some embodiments. In one embodiment, the query processor 100 may determine that two or more identities are related to one profile of the streaming or batch query 111. In embodiments, the query processor 100 may determine that one or more of the plurality of fragments (i.e., being continually generated based on the data feeds 107 and 109 arriving at the query processor 100) correspond to the one or more identities that are determined to be related to the one profile of the streaming or batch query 111. For example, using the one or more identities that have been determined to have a relationship to one another based on the identity-based graph, the query processor 100 may identify one or more of the plurality of fragments that correspond to at least one of the one or more identities. In one embodiment, the query processor 100 may determine that one or more of the plurality of fragments (i.e., being continually generated based on the data feeds 107 and 109 arriving at the query processor 100) correspond to the two or more identities that are determined to be related to the one profile of the streaming or batch query 111. In some embodiments, fragments may be determined to correspond to one or more identities on a one-to-one basis (1:1). In other embodiments, fragments may be determined to correspond to identities at any ratio. In one example, an identity in the identity-graph may not have (i.e., may lack) a corresponding fragment in the hydration environment 108. In another example, one identity in the identity-graph may have a plurality of corresponding fragments in the hydration environment 108. As such, the examples herein are for illustration and should not be construed as limiting.

The query processor 100 may comprise a unification component 112. The unification component 112 of the server may generate a “unified” profile data model. For simplicity, the terms “unified profile data model” and “unified profile” are used interchangeably herein. In embodiments, a unified profile is a logical collection of one or more profile fragments for one or more identities that correspond to a particular user.

The unified profile is generated in response to receipt of the streaming or batch query 111, and the unified profile is generated through the process described above involving creation of the identity-based graph and determinations of corresponding fragments. In embodiments, the unification component 112 generates a unified profile based on the one or more fragments that have been determined to correspond to the one or more identities that are related to the one profile of the streaming or batch query 111. The unified profile may comprise an aggregation of the two or more of the plurality of fragments that were determined to correspond to the one or more identities that were determined to be related to the one profile of the streaming or batch query 111. In one embodiment, the unification component 112 generates a unified profile based on the one or more fragments that have been determined to correspond to two or more identities that are related to the one profile of the streaming or batch query 111. In such an embodiment, the unified profile may comprise an aggregation of the two or more of the plurality of fragments that were determined to correspond to the two or more identities that were determined to be related to the one profile of the streaming or batch query 111.

For example, the one or more fragments corresponding to the identities, as determined by the query processor 100, may be stitched together by the unification component 112 to generate one document or one object, wherein the document or object is the unified profile. In another example, all of the fragments that are determined to correspond to any one of the related identities, as determined by the query processor 100, may be stitched together or concatenated together by the unification component 112 to generate one document or one object, wherein the document or object is the unified profile. Accordingly, the unified profile is specific to one particular profile for one user, in embodiments.

In various embodiments, the unified profile is generated using the specially configured components of the query processor 100, discussed above. The unified profile is a hybrid data model that is built by leveraging the near real-time, dynamic relationship determinations of the identity component 110, and the on-going population of fragments in the hydration environment 108. The dynamic relationship determinations of the identity component 110 reflect a new implementation of an aspect of an identity-based document-oriented data model, whereas the on-going population of fragments in the hydration environment 108 reflects a new implementation of an aspect of a type-based relational data model. For example, a unified profile may comprise both time invariant data sets and time-series data sets. FIG. 2 depicts a simplified representation of a unified profile. In FIG. 2, a group of individual profile fragments (e.g., “CRM dataset”) that have been generated from data feeds are shown, and identities (“CRMID”) that correspond to particular profile fragments are shown, with a line representing a linking of an identity to a particular fragment. It will be understood that FIG. 2 is a simplification meant to present the detailed concepts further discussed herein in a graphic and easy-to-understand manner. Other technologies do not implement aspects of both identity-based document-oriented data models and type-based relational data models, in contrast to the embodiments of the unified profile. Once generated, the streaming or batch query 111 is executed by the query processor 100 against the unified profile in order to return information in response to the streaming or batch query 111. The unified profile may be communicated to any entity, whether local or remote to the query processor 100, as a response to the streaming or batch query 111. For example, the unified profile may be communicated and/or stored in a profile store 116.

The embodiments discussed herein provide technological solutions that are technological improvements over other technologies, and that support new technological functions relative to other technologies. For example, the unified profile obviates the need to perform a “hard merge,” and this prevents the data loss experienced in other technologies that rely on or require a hard merge. Further, through the unified profile, the query processor 100 can handle both analytical workloads and operational workloads.

In contrast, for example, OLAP data models (i.e., a type-based relational data model) cannot handle operational workloads, and OLTP data models (i.e., another type-based relational data model) cannot handled queries, as the processes are resource expensive. The unified profile however, support both operational workloads and queries efficiently. In contrast to unified profile, OLAP data models (i.e., a type-based relational data model) cannot perform a single profile lookup, streaming segmentation, and machine learning workloads whereas the unified profile hybrid data model can. Additionally, an identity-based document-oriented data model cannot handle time-series queries whereas the unified profile hybrid data model can. Unlike other technologies, the unified profile data model and query processor 100 can process interactive queries, single profile lookups, streaming segmentation, machine learning workloads, operational stores, real-time batch segmentation, and time-series queries. Thus, the unified profile hybrid data model discussed herein includes concurrent technological capabilities that are not present in any one data model and overcomes the limitations of those data models, such that the unified profile hybrid data model provides technological solutions and improvements over other technologies.

### Example Methods

Turning now to FIGS. 3 and 4, methods are discussed that can be performed via one or more of the components and component interactions previously described in FIGS. 1 and 2. As such, the methods are discussed briefly for brevity, though it will be understood that the previous discussion and details described therein can be applicable to aspects of the methods of FIGS. 3 and 4. Additionally or alternatively, it will be understood that the methods discussed herein can be implemented or performed via the execution of computer-readable instructions stored on computer readable media, by one or more processors. In various embodiments, the methods discussed herein with regard to FIGS. 3 and 4 may be computer-implemented methods. In one embodiment, one or more non-transitory computer-readable media having computer-readable instructions or computer-readable program code portions embodied thereon, for execution via one or more processors, may be used to implement and/or perform the methods discussed with regard to FIGS. 3 and 4. For example, computer-readable instructions or computer-readable program code portions can specify the performance of the methods with regard to FIGS. 3 and 4, may specify a sequence of steps of the methods, and/or can identify particular component(s) of a software and/or hardware for performing one or more of the steps of the methods, in embodiments. As discussed herein, the methods of FIGS. 3 and 4 may be performed using software, hardware, component(s), and/or the devices depicted in the example of FIG. 1. For example, one or more steps of the methods discussed hereinafter can be performed at the query processor 100 of FIG. 1, using one or more processors.

Beginning with FIG. 3, a method 300 is provided for generating a unified profile hybrid data model. At block 302, a plurality of fragments are generated for a plurality of identities. The plurality of fragments are generated from at least one data feed, the at least one data feed having a corresponding identity, in embodiments. In some embodiments, the plurality of fragments are generated from a plurality of data feeds, each of the plurality of data feeds having a corresponding identity. Accordingly, an identity of a data feed is determined, for example, and a fragment is generated for that identity of the data feed. Thus, the fragment corresponds to the identity, in embodiments. The plurality of fragments are generated in an on-going or continual manner, as data is received through the data feeds, in embodiments, such that the method 300 involves data in motion. In embodiments, a profile fragment is created as a document, using a data set received in a data feed. A profile fragment is generated by using a data set to create a document that contains the data set, in one embodiment. For example, in a data feed, data sets comprising user's contact information, a user's first name, a user's last name, a user's mailing address, a user's electronic address, and transaction information of a user's purchase online is received (e.g., a credit card number, product data for the purchased good). In the example a profile fragment (e.g., a document) is created that comprises the data encoding the user's first name, another profile fragment is created that comprises the data encoding user last name, yet another profile fragment is created that comprises the user's mailing address, and another profile fragment is created that comprises the product data, and so on. As such, discrete pieces of information encoded in the data feed are isolated and used to create discrete documents, referred to as profile fragments. The data sets used to create profile fragments may be structured, semi-structured, or unstructured, in embodiments, such that data feeds of diverse data structures (e.g., data belonging to different types of data models) are streamed and used to build the plurality of fragments.

In various embodiments, a plurality of identities correspond to a plurality of data feeds such that each one of the plurality of fragments corresponds to one of the plurality of identities. Generally, the data feeds may correspond to different “channels” with regard to identity. For example, one data feed may correspond to a channel of CRM data (e.g., identity “CRM”) and another data feed may correspond to behavioral or transaction data, such that the two data feeds have a different data structure and/or data format. Accordingly, a plurality of data feeds may comprise a plurality of different data structures and/or data formats, in embodiments, such that the data feeds comprise diverse and different data sets as input. For example, different data structures and/or formats may include impression data, website data, and/or transaction data.

At block 304, one or more relationships between the plurality of identities are determined. In embodiments, the identities of the data feeds are determined and relationships between the identities may be discerned. For example, it may be determined by a query processor 100 and/or the identity component 110, such as those shown in the example of FIG. 1, that a credit card ID of one data feed is related to or matches an email ID, and further, that the email ID is connected to or related to a cookie, based on a user login data. In some embodiments, identity-to-identity relationships are determined when channel (data feed) interactions are identified, such as one data feed being related to another data feed. In embodiments, one or more relationships are identified by identifying shared or linked or corresponding data and/or linked information between a two or more identities. In some embodiments, one or more relationships between the plurality of identities may be determined, for example, using deterministic signals and/or probabilistic matching. For example, one or more relationships between a plurality of identities may be determined when two or more identities, such as “email” and “cookie,” for example, occur and/or are present within one event, such as a login event, for example. The presence and/or occurrence of two or more identities within one event may be used to determine and create a relationship between the two or more identities, in some embodiments.

Generally, the identities of the data feeds are stored separately from the fragments, for example, in a separate or partitioned environment. As the identities are kept separate from the fragments, the one or more relationships between the plurality of identities are determined independently of the plurality of fragments, in embodiments. In this manner, the one or more relationships between identities are capable of evolving over time, separately from the fragments, as continually discerned based on the continual arrival of new data from the data feeds, in some embodiments. This enables a dynamic (i.e., not static) view of the relationships between identities to be created and updated in near real-time. This dynamic identity and relationship determination environment overcomes the limitations of prior technologies, which required a hard merge that relied on identities and/or relationships that were static and unchanging. Accordingly, the one or more relationships between the plurality of identities are determined in an on-going or continual manner, as data is received through the data feeds. Additionally, in some embodiments, the one or more relationships and the plurality of fragments are determined and generated concurrently, though separately.

A query, such as a streaming or batch query, may be received at any time. At block 306, based on receiving a query, an identity-based graph is generated. As previously described, the identity-based graph provides a snapshot of the relationships between identities that have been determined to exist at the time of the query. Accordingly, the identity-based graph represents the one or more relationships that are determined between the plurality of identities, in embodiments. For example, the identity-based graph may comprise a representation that a relationship exists, at that time of generating the identity-based graph, between a credit card ID and an email ID, and between the email ID and a cookie, and further, that the credit card ID is related to the cookie.

Turning to block 308, at least one identity in the identity-based graph is determined to correspond to the query. In some embodiments, the query specifies a data set or a data point having a first identity, and at least one identity in the identity-based graph may be determined to correspond to the first identity specified in the data set or data point of the query. For example, it may be determined that the credit card ID corresponds to the query, based on a data set or data point in the query that includes or comprises the credit card ID. In a further example, it may be determined that the cookie and the email ID also correspond to the query, based on a data set or data point in the query including the credit card ID. In another example, a credit card ID may be a field in an event (e.g., login event) or an attribute value in profile data. In this example, when the query refers to one or more of the field or the attribute value, the credit card ID may be determined to be related to the query. In an embodiment, the query may specify an identity via a merge rule. In some embodiments, a plurality of identities are determined to correspond to the query based on the one or more relationships represented within the identity-based graph that was generated. In one embodiment, for each query in the plurality of queries in the streaming or batch query (i.e., for all of the queries to be run against one profile for one user), the relationships between various identities are determined with respect to each query, such that all the queries are addressed at one time.

At block 310, one or more of the plurality of fragments are determined to correspond to the at least one identity. For example, based on determining that the credit card ID, email ID, and cookie are related identities with a relationship in the identity-based graph, the plurality of fragments are searched to determine which of the plurality of fragments correspond to one or more of the identities of a credit card ID, an email ID, and/or a cookie. In embodiments, one or more of the plurality of fragments have an identity that corresponds to the at least one identity determined from the identity-based graph relationships. In a further embodiment, two or more of the plurality of fragments have identities that correspond to the at least one identity determined from the identity-graph. In yet another embodiment, at least two of the plurality of fragments correspond to identities that correspond to two or more of the related identities determined from the identity graph. In some embodiments, all of the fragments that correspond to any of the identities that are related to the query and the relationships represented in the identity-based graph are fragments that are determined and recognized for the next step of generating a unified profile data model. In some embodiments, for each query in the plurality of queries in the streaming or batch query, the plurality of fragments that correspond to the related identities are determined with respect to each query such that all the queries are being addressed at one time.

At block 312, a unified profile is generated. The unified profile comprises an aggregation of the one or more of the plurality of fragments determined to correspond to the at least one identity. In embodiments, the one or more of the plurality of fragments may include time invariant data and time-series data, which are aggregated together to form the unified profile. The unified profile, in some embodiments, is a single document formed by concatenating the plurality of fragments that correspond to the at least one identity in the identity-based graph, the at least one identity corresponding to the query. In further embodiments, all of the fragments that were determined to correspond to any of the identities that are related to the query and relationships represented in the identity-based graph are aggregated together to form one document, or one object, wherein the document or object is the unified profile data model. For example, the unified profile may be a single object having a JavaScript Object Notation (JSON) data format, wherein the single object is an aggregated combination of the plurality of fragments that correspond to the at least one identity in the identity-based graph that corresponds to the query. In some embodiments, the unified profile is generated by performing a run-time merge of the one or more of the plurality of fragments related to the identities that were determined based on the streaming or batch query. As such, the unified profile may comprise data of more than one divergent data model such that the unified profile is a hybrid data model.

Accordingly, the query is processed against the unified profile to completion, for example, to return results that are responsive to the query. Generally, the hybrid nature of the unified profile data model renders the unified profile data model compatible with operational workloads, analytical workloads, and time-series queries. In further embodiments, all of the queries in a streaming or batch query are processed against the unified profile together, at one time.

Turning to FIG. 4, a flowchart of a method 400 for generating a unified profile that is a hybrid data model is depicted. At block 402, a plurality of data feeds are received, as has been previously discussed. At block 404, a plurality of identities for the plurality of data feeds are determined in near real-time with receiving the plurality of data feeds. Accordingly, as data from the data feeds is streamed, an identity is determined at that time for each of the data feeds, in embodiments.

In accordance with the method at block 406, a plurality of fragments are generated for the plurality of identities in near real-time with determining the plurality of identities, wherein each one of the plurality of fragments corresponds to one of the plurality of identities. For example, as data from the data feeds arrives, fragments are generated from the data. Fragments correspond to the identity that is determined for the data feed from which the data used to build the fragment was obtained, for example. Thus, in some embodiments, the plurality of fragments are being continually generated as data is received from data feeds in on a continual basis.

At block 408, a plurality of relationships between the plurality of identities are determined in near real-time with determining the plurality of identities, wherein the plurality of relationships are determined independent of the plurality of fragments. As mentioned previously, by enabling the identity-to-identity relationships to be discerned, in near real-time as the data feeds continue to supply data and as identities of data feeds are determined, it further enables the identity relationships to change dynamically over time based on additional and/or new data. In some embodiments, the plurality of identities are being continually determined.

A query is received, at block 410, and the query comprises a plurality of queries that correspond to one profile. Turning to block 412, in response to the query, an identity-based graph that represents the plurality of relationships being determined in near real-time is generated. At block 414, it is determined that two or more of the plurality of identities are related to the one profile of the query, based on the plurality of relationships in the identity-based graph. Two or more of the plurality of fragments are determined, at block 416, to correspond to the two or more of the plurality of identities that are related to the one profile of the query. At block 418, a unified profile is generated that comprises an aggregation of the two or more of the plurality of fragments that correspond to the two or more of the plurality of identities that are related to the one profile of the query. In some embodiments, the unified profile is generated by performing a run-time merge of the two or more of the plurality of fragments related to the profile of the query. As such, the unified profile may comprise data of more than one divergent data model, such that the unified profile is a hybrid data model. Shown at block 420, the query is processed against the unified profile to completion.

### Example Operating Environment

Turning to FIG. 5, it depicts a block diagram of a computing device 500 suitable to implement embodiments of the present invention. It will be understood by those of ordinary skill in the art that the computing device 500 is just one non-limiting example of a suitable computing device and is not intended to limit the scope of use or functionality of the present invention. Similarly, the computing device 500 should not be interpreted as imputing any dependency and/or any requirements with regard to each component and combination(s) of components illustrated in FIG. 5. It will be appreciated by those having ordinary skill in the art that the connections illustrated in FIG. 5 may comprise other methods, hardware, software, and/or devices for establishing a communications link between the components, devices, systems, and entities. Although the connections are depicted using one or more solid lines, it will be understood by those having ordinary skill in the art that the connections of FIG. 5 may be hardwired or wireless, and may use intermediary components that have been omitted or not included in FIG. 5 for simplicity's sake. As such, the absence of components from FIG. 5 should be not be interpreted as limiting the present invention to exclude additional components and combination(s) of components. Moreover, though devices and components are represented in FIG. 5 as singular devices and components, it will be appreciated that some embodiments may include a plurality of the devices and components such that FIG. 5 should not be considered as limiting the number of a devices or components.

Continuing, the computing device 500 may be in the form of a server, in some embodiments. Although illustrated as one component in FIG. 5, the present invention may utilize a plurality of local servers and/or remote servers in the computing device 500. The computing device 500 may include components such as a processing unit, internal system memory, and a suitable system bus for coupling to various components, including a database or database cluster. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The computing device 500 may include or may have access to one or more computer-readable media. Computer-readable media may be any available media that may be accessed by the computing device 500. Computer-readable media may include one or more of volatile media, nonvolatile media, removable media, or non-removable media. By way of a non-limiting example, computer-readable media may include computer storage media and/or communication media. Non-limiting examples of computer storage media may include one or more of volatile media, nonvolatile media, removable media, or non-removable media, and may be implemented in any method and/or any technology for storage of information, such as computer-readable instructions, data structures, program modules, or other data. In this regard, non-limiting examples of computer storage media may include Random Access Memory (RAM), Read-Only Memory (ROM), Electrically Erasable Programmable Read-Only Memory (EEPROM), flash memory or other memory technology, CD-ROM, digital versatile disks (DVDs) or other optical disk storage, magnetic cassettes, magnetic tape, magnetic disk storage, or other magnetic storage device, or any other medium which may be used to store information and which may be accessed by the computing device 500. Generally, the computer storage media is non-transitory such that it does not comprise a signal per se.

Communication media may embody computer-readable instructions, data structures, program modules, and/or other data in a modulated data signal, such as a carrier wave or other transport mechanism. Communication media may include any information delivery media. As used herein, the term “modulated data signal” refers to a signal that has one or more of its attributes set or changed in such a manner as to encode information in the signal. Non-limiting examples of communication media may include wired media, such as a wired network connection, a direct-wired connection, and/or a wireless media, such as acoustic, radio frequency (RF), infrared, and other wireless media. Combinations of any of the above also may be included within the scope of computer-readable media.

Continuing with FIG. 5, a block diagram of a computing device 500 suitable for providing packing instructions is provided, in accordance with an embodiment of the technology. It should be noted that although some components depicted in FIG. 5 are shown in the singular, they may be plural, and the components may be connected in a different, including distributed, configuration. For example, computing device 500 may include multiple processors and/or multiple radios. As shown in FIG. 5, computing device 500 includes a bus 502 that may directly or indirectly connect different components together, including memory 504 and a processor 506. In further embodiments, the computing device 500 may include one or more of an input/output (I/O) port 508, I/O component 510, or communication component 512. The computing device 500 may be coupled to a power supply 514, in some embodiments.

Memory 504 may take the form of the memory components described herein. Thus, further elaboration will not be provided here, but it should be noted that memory 504 may include any type of tangible medium that is capable of storing information, such as a database. A database may include any collection of records, data, and/or other information. In one embodiment, memory 504 may include a set of computer-executable instructions that, when executed, facilitate various functions or steps disclosed herein. These instructions will variously be referred to as “instructions” or an “application” for short. Processor 506 may actually be multiple processors that may receive instructions and process them accordingly. Communication component 512 may facilitate communication with a network as previously described herein, whether wirelessly or using a wired connection. Additionally or alternatively, the communication component 512 may facilitate other types of wireless communications, such as Wi-Fi, WiMAX, LTE, Bluetooth, and/or other communications. In various embodiments, the communication component 512 may be configured to concurrently support multiple technologies.

I/O port 508 may take a variety of forms. Example I/O ports may include a USB jack, a stereo jack, an infrared port, a firewire port, and/or other proprietary communications ports. I/O component 510 may comprise one or more keyboards, microphones, speakers, touchscreens, and/or any other item useable to directly or indirectly input data into the computing device 500. Power supply 514 may include batteries, fuel cells, and/or any other component that may act as a power source to supply power to computing device 500 or to other components.

Although internal components of the computing device 500 are not illustrated for simplicity, those of ordinary skill in the art will appreciate that internal components and their interconnection are present in the computing device 500 of FIG. 5. Accordingly, additional details concerning the internal construction of the computing device 500 are not further disclosed herein.

Many modifications and other embodiments of the inventions set forth herein will come to mind to one skilled in the art to which these inventions pertain having the benefit of the teachings presented in the foregoing description and the associated drawings. Therefore, it is to be understood that the inventions are not to be limited to the specific embodiments disclosed and that modifications and other embodiments are intended to be included within the scope of the appended claims. Although specific terms are employed herein, they are used in a descriptive sense only and not for purposes of limitation, unless described otherwise.

What is claimed is:

1. One or more computer-readable media having computer instructions stored thereon for execution by one or more processors, wherein execution of the computer instructions by the one or more processors provides a method, the method comprising:
generating a plurality of fragments for a plurality of identities that correspond to a plurality of data feeds, wherein each one of the plurality of fragments corresponds to one of the plurality of identities;
determining one or more relationships between the plurality of identities that correspond to the plurality of data feeds;
based on receiving a query, generating an identity-based graph that represents the one or more relationships determined between the plurality of identities;
determining that at least one identity in the identity-based graph corresponds to the query;
determining one or more of the plurality of fragments correspond to the at least one identity; and
generating a unified profile comprising an aggregation of the one or more of the plurality of fragments determined to correspond to the at least one identity.

2. The media of claim 1, wherein the plurality of data feeds comprise a plurality of different data formats, the plurality of different data formats comprising two or more of impression data, website data, and transaction data.

3. The media of claim 1, wherein the plurality of fragments are stored separately from the identity-based graph.

4. The media of claim 1, wherein the one or more relationships between the plurality of identities are determined independently of the plurality of fragments generated.

5. The media of claim 1, wherein the query specifies a data point having a first identity, and wherein the at least one identity in the identity-based graph is determined to correspond to the first identity specified in the data point of the query.

6. The media of claim 1, wherein the unified profile is compatible with an operational workload and a time-series query.

7. The media of claim 1, wherein the unified profile is an aggregation of the one or more of the plurality of fragments determined to correspond to the at least one identity that corresponds to the query.

8. The media of claim 1, wherein the unified profile is a single document comprising a concatenation of the one or more of the plurality of fragments determined to correspond to the at least one identity that corresponds to the query.

9. The media of claim 1, wherein the unified profile is a single object having a JavaScript Object Notation (JSON) data format, and wherein the single object is an aggregation of the one or more of the plurality of fragments that correspond to the at least one identity that corresponds to the query.

10. One or more computer-readable media having computer instructions stored thereon for execution by one or more processors, wherein execution of the computer instructions by the one or more processors provides a method, the method comprising:
receiving a plurality of data feeds;
determining a plurality of identities for the plurality of data feeds in near real-time with receiving the plurality of data feeds;
generating a plurality of fragments for the plurality of identities in near real-time with determining the plurality of identities, wherein each one of the plurality of fragments corresponds to one of the plurality of identities;
determining a plurality of relationships between the plurality of identities in near real-time with determining the plurality of identities, wherein the plurality of relationships are determined independent of the plurality of fragments;
receiving a query that comprises a plurality of queries corresponding to one profile;
in response to the query, generating an identity-based graph that represents the plurality of relationships being determined in near real-time;
determining that two or more of the plurality of identities are related to the one profile of the query based on the plurality of relationships in the identity-based graph;
determining that two or more of the plurality of fragments correspond to the two or more of the plurality of identities that are related to the one profile of the query;
generating a unified profile that comprises an aggregation of the two or more of the plurality of fragments that correspond to the two or more of the plurality of identities that are related to the one profile of the query; and
processing the query against the unified profile.

11. The media of claim 10, wherein the plurality of data feeds comprises a plurality of different data formats, the plurality of different data formats comprising two or more of impression data, website data, and transaction data.

12. The media of claim 10, wherein the plurality of fragments are stored separately from the identity-based graph.

13. The media of claim 10, wherein the one or more relationships between the plurality of identities are determined independently of the plurality of fragments generated.

14. The media of claim 10, wherein the query specifies a data point having a first identity, and wherein at least one of the two or more of the plurality of identities in the identity-based graph is determined to correspond to the first identity specified in the data point of the query.

15. The media of claim 10, wherein the unified profile is compatible with an operational workload based on the plurality of fragments being separate from the identity-based graph and based on a sequenced structure of the two or more of the plurality of fragments as aggregated into the unified profile.

16. The media of claim 10, wherein the unified profile is an aggregation of the two or more of the plurality of fragments determined to correspond to the two or more of the plurality of identities.

17. The media of claim 10, wherein the unified profile is a single document comprising a concatenation of the two or more of the plurality of fragments that correspond to the two or more of the plurality of identities in the identity-based graph that correspond to the query.

18. The media of claim 10, wherein the unified profile is a single object having a JavaScript Object Notation (JSON) data format, and wherein the single object is an aggregation of the two or more of the plurality of fragments that correspond to the at least one identity in the identity-based graph that corresponds to the query.

19. The media of claim 10, wherein the query comprises a plurality of queries, and wherein the method comprises determining, for each of the plurality of queries, that two or more of the plurality of identities are related to the one profile based on the plurality of relationships in the identity-based graph.

20. A computer system comprising:
means for generating a hydration environment and a separate identity-graph environment; and
means for generating, in response to a query, a unified profile using one or more relationships of the identity-graph environment and a plurality of fragments of the hydration environment.
